(19) United States
(12) Patent Application Publication
(10) Pub. No.: US 2012/0084299 A1
(43) Pub. Date: Apr. 5, 2012

(54) MATCHING INFORMATION OF CHEMICAL SUBSTANCE

(75) Inventors: Keke CAI, Beijing (CN); HongLei GUO, Beijing (CN); Zhong SU, Beijing (CN); Xian WU, Beijing (CN); Li ZHANG, Beijing (CN)

(73) Assignee: INTERNATIONAL BUSINESS MACHINES CORPORATION, Armonk, NY (US)

(21) Appl. No.: 13/248,268

(22) Filed: Sep. 29, 2011

(30) Foreign Application Priority Data
Sep. 29, 2010 (CN) 201010299057.8

(51) Int. Cl. G06F 17/30

(52) U.S. Cl. 707/748; 707/821; 707/E17.01; 707/E17.084

(57) ABSTRACT

This disclosure provides methods and systems for processing and matching information of a chemical substance, and a storage system. According to one embodiment of the present invention, a method of processing information of a chemical substance comprises obtaining substructures of a chemical structural formula of said chemical substance; determining a featured substructure of said chemical substance from the obtained substructures; and storing said featured substructure of said chemical substance. The technical problem to be solved by one aspect of this disclosure is to provide a method and system capable of processing and/or matching information of a chemical substance independent of the existing various nomenclatures. One aspect of this disclosure provides a method and system for efficiently and comprehensively indexing and/or inquiring about information of a chemical substance using a featured substructure, and a storage system of the same.

### CROSS-REFERENCE TO RELATED APPLICATIONS

This application is based upon and claims priority from prior Chinese Patent Application No. 201010299057.8, filed on Sep. 29, 2010, the entire disclosure of which is herein incorporated by reference.

### FIELD OF THE INVENTION

This disclosure relates to the chemical information processing technology, and more specifically, to methods and systems for storing and matching information of a chemical substance, and a storage system.

### BACKGROUND OF RELATED ART

As is well known, the terminology in the chemical field is quite complex and inconsistent. Taking chemical name for example, there are multiple incompatible nomenclatures as follows:
IUPAC nomenclature: it is a systematic method of naming chemical compounds. This nomenclature describes each compound having an explicit structural formula with a specified name and facilitates communication between researchers under no ambiguity. Meanwhile, the IUPAC nomenclature also accepts the customary ordinary naming of some substances and basic groups.
SMILES nomenclature: SMILES is a specification for unambiguously describing the structure of chemical molecules using short ASCII character strings. SMILES strings can be imported by most molecule editors for conversion back into two-dimensional drawings or three-dimensional models of the molecules.
IUPAC International Chemical Identifier (InChi) nomenclature: similar to SMILES, InChi is also a textual identifier for representing structures of chemical substances. Inchi is readable and can be used to establish a structure indexing database.

CAS Registry Numbers (or called CAS Numbers, CAS Rn, CAS #): CAS Registry Numbers are unique numerical identifiers for organic and inorganic compounds, metals, alloys, elements, proteins & nucleic acids, polymers, etc.

In the above-mentioned nomenclatures, SMILES and INCHI focus on representing molecular structures, while IUPAC provides abstract representation and CAS Numbers use numerical coding without semantic meanings.

Besides the different types of heterogeneous chemical nomenclatures, even in one nomencluature, synonymous name (also called synonym) for a chemical name is very common. According to the statistics of DrugBank®, for a drug Valium, DrugBank gives 117 synonyms including Clobazam, Alboral, Duxen, Paceum, Solis and so on.

During the past decades, the fast development of information technology realizes its application in the chemical information processing field. For example, some technologies construct structural index by analyzing INCHI names of chemical substances and implement structure search for chemical names; some technologies extract, from IUPAC chemical names, a sub character string which occurs most frequently as an index, and retrieve all chemical names containing the sub character string; In addition, there are systems which provide interfaces for drawing chemical structures, users can draw a molecular structure as a query, and search for chemical compounds according to chemical structure similarity. However, these technologies do not analyze chemical structures from the angle of functionality and thus cannot obtain synonyms of a certain chemical substance that are named using the same nomenclature from the angle of functionality, to say nothing of synonyms named using other nomenclatures.

### SUMMARY OF THE INVENTION

According to the above, the prior art has the following drawbacks: first, only one nomenclature is used to make a query, but this query usually requires complete match so that it is hard to search for the same substance named using other nomenclatures; second, it is difficult for these technologies to search for chemical substances which have the same or similar functions but have different names; third, there are already some matching methods based on structural similarity, but since chemical structures are quite complicated, the simple application of structure matching cannot find the matches having the same or similar efficacies. That is to say, in the chemical information processing field, all synonyms of a chemical substance still cannot be obtained on the basis of any specified naming or structural formula of the chemical substance by using the prior-art information technologies.

Therefore, there is a need in the prior art for a method and system for processing and/or matching information of a chemical substance independently of nomenclatures, and a storage system.

In view of the foregoing problems existing in the prior art, one aspect of the present disclosure provides a method and system for efficiently and comprehensively indexing and/or inquiring about information of a chemical substance using the featured substructures, and a storage system.

According to one embodiment of the present disclosure, there is provided a method and system for using a chemical structural formula for chemical information processing. In this chemical information processing system, a chemical substructure of a chemical substance which has a functional discrimination, instead of a chemical name or an ordinary substructure which is extracted according to frequency, is used as the basic unit of indexing and searching. In this case, one embodiment of the present disclosure solves the multiple nomenclatures and grouping synonym problem encountered in the chemical field. More specifically, one embodiment of the present disclosure can obtain information of chemical substances having the same or similar functions independently of naming under any specific nomenclature.

The embodiments of the present invention can be implemented in multiple modes comprising a method or system. Several embodiments of the present invention are discussed below.

As a method of processing information of a chemical substance, one embodiment of the present invention comprises at least the following operations: obtaining substructures of a chemical structural formula of said chemical substance; determining the featured substructures of said chemical substance from the obtained substructures; and storing said featured substructure of said chemical substance.

As a method of inquiring about information of a chemical substance, one embodiment of the present invention at least comprises: obtaining a query request for the chemical substance; and obtaining a featured substructure of the chemical substance to be inquired about.

As a storage system for storing a chemical substance and a featured substructures in association with each other, one embodiment of the present invention at least comprises: interface means for, responsive to an external request, transmitting information of said chemical substance and its featured substructure; and storage means, coupled to said interface means, for storing the information of the chemical substance and its featured substructure in association with each other.

As a system for processing information of a chemical substance, one embodiment of the present invention at least comprises: substructure obtaining means for obtaining substructures of a chemical structural formula of said chemical substance; featured substructure determining means for determining featured substructures of said chemical substance from the obtained substructures; and storage means for storing said featured substructures of said chemical substance.

As a system for inquiring about information of a chemical substance, one embodiment of the present invention at least comprises: receiving means for obtaining a query request for the chemical substance; and featured substructure obtaining means for obtaining featured substructures of the chemical substance to be inquired about.

One of the embodiments of the present invention provides at least the following advantage: it is capable of identifying synonyms of a chemical substance independently of a nomenclature.

### BRIEF DESCRIPTION OF THE DRAWINGS

FIG. 1 is a schematic flow diagram showing a method of associating a chemical structural formula of a chemical substance with information of the chemical substance according to one embodiment of the present invention.

FIG. 2 is a schematic flow diagram showing the steps comprised in step 103 shown in FIG. 1 according to one embodiment of the present invention.

FIG. 3 is a schematic flow diagram showing the steps comprised in step 105 shown in FIG. 1 according to one embodiment of the present invention.

FIG. 4 is a schematic flow diagram showing a method of matching a chemical substance based on a chemical structural formula of the chemical substance according to one embodiment of the present invention.

FIG. 5 is a schematic flow diagram showing the steps comprised in step 405 shown in FIG. 4 according to one embodiment of the present invention.

FIG. 6 is a schematic flow diagram showing the steps comprised in step 407 shown in FIG. 4 according to one embodiment of the present invention.

FIG. 7 is a schematic view showing an example of the application of one embodiment of the present invention in the biomedical field.

FIG. 8 is a schematic block diagram showing a system for storing and matching a chemical structural formula according to one embodiment of the present invention.

### DETAILED DESCRIPTION OF THE EMBODIMENTS

In the following discussion, a great amount of concrete details are provided to help thoroughly understand the present invention. However, it is apparent to those of ordinary skill in the art that even though there are no such concrete details, the understanding of the present invention would not be influenced. In addition, it should be further appreciated that any specific terms used below are only for the convenience of description, and thus the present invention should not be limited to only use in any specific applications represented and/or implied by such terms.

Before specifically describing the present invention, the terms appearing in this paper are first explained. A “substructure” refers to a part or whole of a chemical structural formula of a chemical substance. A “featured substructure” refers to a substructure having a functional discrimination, and more specifically to a substructure shared by a part or whole of the chemical substances having the same or similar functions, and this substructure typically represents one or more functions.

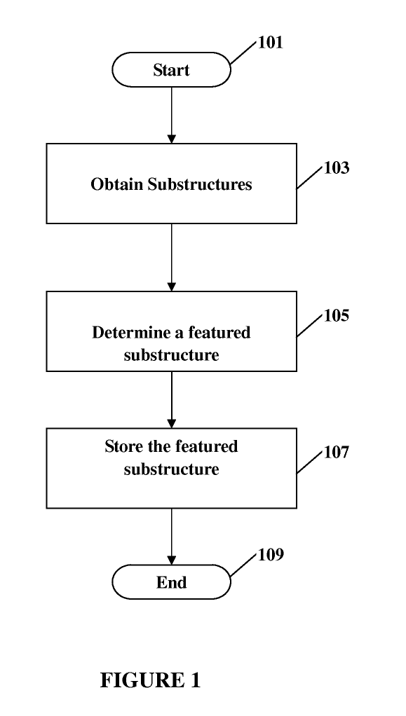

FIG. 1 is a schematic flow diagram showing a process of indexing a chemical substance based on a chemical structural formula of the chemical substance according to one embodiment of the present invention.

At step 101, the process starts.

At step 103, substructures of a chemical structural formula of the chemical substance are obtained based on the obtained information about the chemical substance.

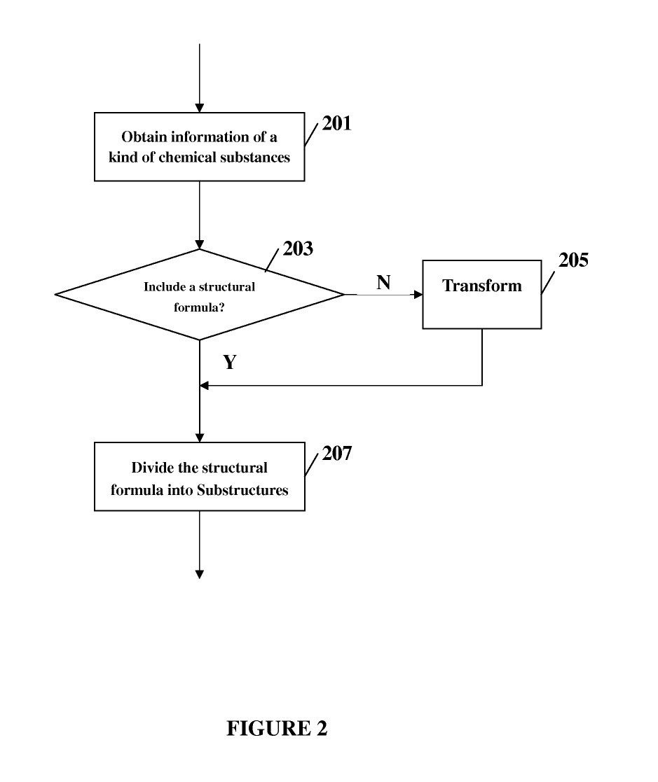

FIG. 2 is a schematic flow diagram showing the steps comprised in step 103 shown in FIG. 1 according to one embodiment of the present invention.

As shown in FIG. 2, once the process proceeds to step 103, step 201 is first executed. At step 201, it is possible to obtain information of a kind of chemical substances having the same or similar functions according to the existing data.

Here, it should be explained that a kind of chemical substances obtained may comprise one or more chemical substances having the same or similar functions. If information of a plurality of chemical substances is obtained, it is necessary to execute the process shown in FIG. 2 with respect to information of each chemical substance, until all substructures of the plurality of chemical substances having the same or similar functions are obtained.

It should be further explained that, in the following, for the convenience of explanation, a chemical substance as a processed subject in the steps shown in FIG. 2 is called a “chemical substance”, and the chemical substances among a kind of chemical substances obtained, other than the chemical substance as the processed subject, are called “other chemical substances”.

In the chemical field, the existing data may be data that originates from a business data source such as DrugBank. In addition, in the prior art, there have been the following clustering algorithms which mine data sets having some common attribute from data sources such as medical literature, and these chemical substances having some common attribute are usually the chemical substances having the same or similar functions.

1) LDA (Latent Dirichlet Allocation): it is a topic model and was first presented by a professor from University of California, Berkeley, in 2002, for identification of the document's topics; it is a set probabilistic model, which is mainly used for processing discrete data sets and currently used in text mining in data mining (dm) and natural language processing, and it is mainly used for reducing the dimensionality.

2) LSA (Latent Semantic Analysis): it is a new indexing and searching method, which was proposed by Scott Deerwester, Susan T. Dumais et al. in 1990 Like the traditional vector space model, this method uses vectors to represent terms and documents and determines relationships between the terms and the documents through a relationship (such as an angle) between the vectors.

3) PLSA (Probabilistic Latent Semantic Analysis): it is a classic statistical method evolved from an analysis method based on two-mode and co-occurrence data. PLSA has applications in information retrieval and filtering, natural language processing, machining learning from text and related areas. A difference between PLSA and LSA is that LSA is represented in the form of a singular value decomposition of a co-occurrence table (i.e., a co-occurrence matrix), whereas PLSA is a probabilistic model.

For example, in the biomedical field, it is possible to automatically mine, using these existing technologies, the relationships between drugs, diseases and protein from medical literature such as patent literature (US, WO and EU patent literature) and papers, thereby obtaining information of a plurality of drugs having the same or similar efficacies. The information of a chemical substance obtained using the prior art comprises names of the chemical substance and/or a chemical structural formula of the chemical substance. The names of the chemical substance may be the names that are obtained using various nomenclatures, such as an IUPAC name, a SMILES name, an InChi name, and a CAS Registry Number of the chemical substance. The chemical structural formula of the chemical substance may be presented by an image, a 3D molecular image, etc.

At step 203, it is judged whether the obtained information of the chemical substance includes a chemical structural formula. If it is determined that the chemical structural formula is not included, the process proceeds to step 205; otherwise, the process proceeds to step 207.

At step 205, the obtained information of the chemical substance is transformed into a chemical structural formula of the chemical substance. Then, the process advances to step 207.

At present, there already exist the existing tools such as a name=structure tool provided by Cambridge, and with this tool, a user can transform the names of the chemical substance into the chemical structural formula of the chemical substance.

At step 207, the obtained chemical structural formula is divided into substructures. Subsequently, the process returns to step 105 as shown in FIG. 1.

At step 105, featured substructures of the chemical substance are determined from the obtained substructures.

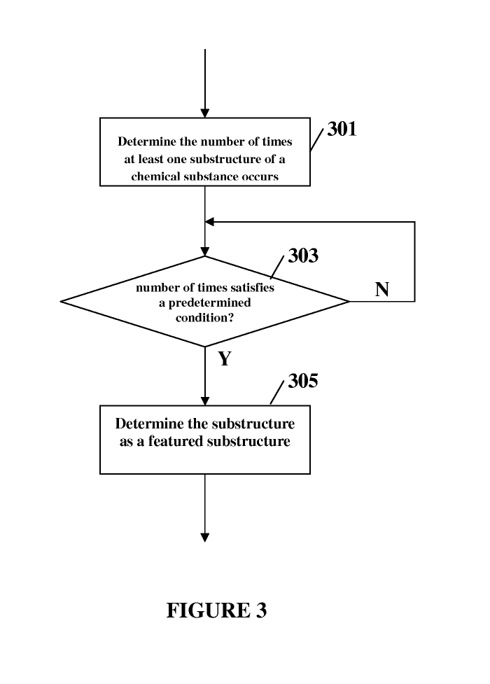

FIG. 3 is a schematic flow diagram showing the steps comprised in step 105 shown in FIG. 1 according to one embodiment of the present invention.

As shown in FIG. 3, once the process proceeds to step 105, step 301 is first executed. At step 301, for the chemical substance obtained at step 103, the number of times at least one substructure of the chemical substance occurs in all substructures of other chemical substances having the same or similar functions obtained at step 103 is determined.

At this step, the statistics of the number of times each substructure of the chemical substance occurs in chemical structural formulas of other chemical substances of the same kind obtained from a function clustering result is taken, and the substructure which occurs at a high frequency is used to represent a feature of the chemical substance.

At step 303, it is judged whether the determined number of occurrences satisfies a predetermined condition. The predetermined condition is one or more of a predetermined threshold of the number of occurrences, a ranking threshold of the number of occurrences, and a predetermined threshold of a ratio of the number of occurrences to the total number of all other chemical substances. If the predetermined condition is satisfied, the process proceeds to step 305; otherwise, the judgment continues to be made directed to a next substructure.

At step 305, the substructure which satisfies the predetermined condition is determined as a featured substructure of the chemical substance.

For example, a group of chemical substances having similar functions includes ChCpd1, ChCpd2 and ChCpd3. ChCpd1 has three substructures SubStr1-1, SubStr1-2 and SubStr1-3, ChCpd2 has five substructures, and ChCpd3 has four substructures. For example, the substructure SubStr1-1 of ChCpd1 occurs in the substructures of ChCpd2 and ChCpd3, SubStr1-2 does not occur in the substructures of ChCpd2 and ChCpd3, and SubStr1-3 only occurs in the substructures of ChCpd2. Then SubStr1-1 occurs 2 times, SubStr1-2 occurs 0 time, and SubStr1-3 occurs 1 time.

Suppose that the predetermined condition is that the number of occurrences is greater than or equal to 1. Then, for the chemical substance ChCpd1, its featured substructures are determined to be SubStr1-1 and SubStr1-3. For another two chemical substances ChCpd2 and ChCpd3, the above-mentioned process can also be executed.

Alternatively, if the predetermined condition is that the number of occurrences ranks top 2, since the numbers of occurrences of the three substructures of ChCpd1 are ranked in the order of SubStr1-1, SubStr1-3 and SubStr1-2, the featured substructures of the chemical substance ChCpd1 are still SubStr1-1 and SubStr1-3. For another two chemical substances ChCpd2 and ChCpd3, the above-mentioned process can also be executed.

Alternatively, if the predetermined condition is that the ratio of the number of occurrences to the total number of all other chemical substances is greater than 50%, since the ratios of the numbers of occurrences of the three substructures SubStr1-1, SubStr1-3 and SubStr1-2 of ChCpd1 to the total number 2 of other chemical substances are 100%, 0 and 50%, respectively, the featured substructure of the chemical substance ChCpd1 is still SubStr1-1.

The aforementioned GraphGrep algorithm presented by Shasha et, al. discloses representation of a chemical structural formula using a substructure which occurs at a high frequency. In the GraphGrep algorithm, all paths of all graphs stored in a database are exhausted, and according to a frequency at which each path occurs among all the paths, a path whose frequency of occurrence reaches or exceeds a certain threshold is used as an index. However, this GraphGrep algorithm does not take functions into consideration, that is to say, it does not determine a graph having a certain function from all graphs in the database and determine a substructure for use as an index with respect to the graph, so that many substructures are useless for the graph. For example, double benzene ring and single benzene ring occur in various chemical substances, but they do not characterize certain functions.

Likewise, in the paper titled “Graph Indexing: A Frequent Structurebased Approach”, by Xifeng Yan et al, SIGMOD 2004 Jun. 13-18, 2004, Paris, France, the division of a chemical structural formula into substructures can be found, and a substructure which occurs at a high frequency is selected as a representative substructure, whereas in the present invention, a featured substructure having a function discrimination is mined.

At step 107, the featured substructure of the chemical substance is stored.

In the prior art, there are already the following modes in which chemical structural formulas are stored:

1) Adjacency Matrix

2) INCHI as aforementioned; and

3) Smiles as aforementioned.

Those skilled in the art should know that, it is possible to store, at step 107, the featured substructure of the chemical substance and other information of the chemical substance (such as naming information using various nomenclatures, which includes one or more of an IUPAC name, a SMILES name, an InChi name, and a CAS Registry Number) in association with each other. Other information and one or more of featured substructures of a chemical substance can be used as indexes for inquiring about said chemical substance and its synonyms.

Note that a preferred method of determining a featured substructure is given above. However, the featured substructure can be either specified by a user according to his or her prior experience or given in other ways.’

At step 109, the process ends.

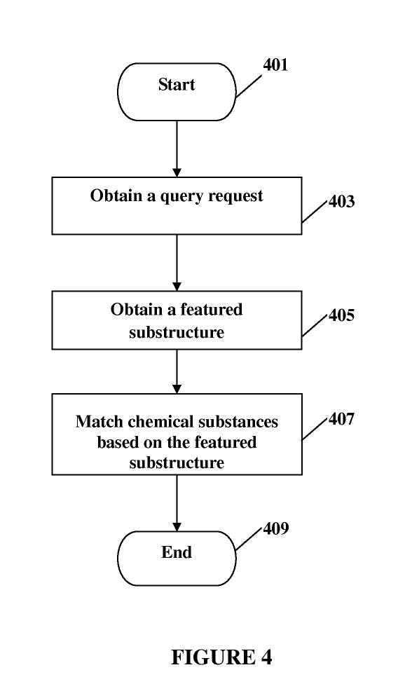

FIG. 4 is a schematic flow diagram showing a method of matching a chemical substance based on a chemical structural formula of the chemical substance according to one embodiment of the present invention.

At step 401, the process starts.

At step 403, a query request for the chemical substance is obtained.

According to one embodiment of the present invention, the query request for the chemical substance is inputted by a user. According to another embodiment of the present invention, the query request for the chemical substance is generated by system. The query request includes names and a molecular structural formula of the chemical substance. Furthermore, the query request may further include a specified substructure, and the user may hope to use the specified substructure as a featured substructure for inquiring about other chemical substances.

At step 405, the featured substructures of the query chemical substance are obtained.

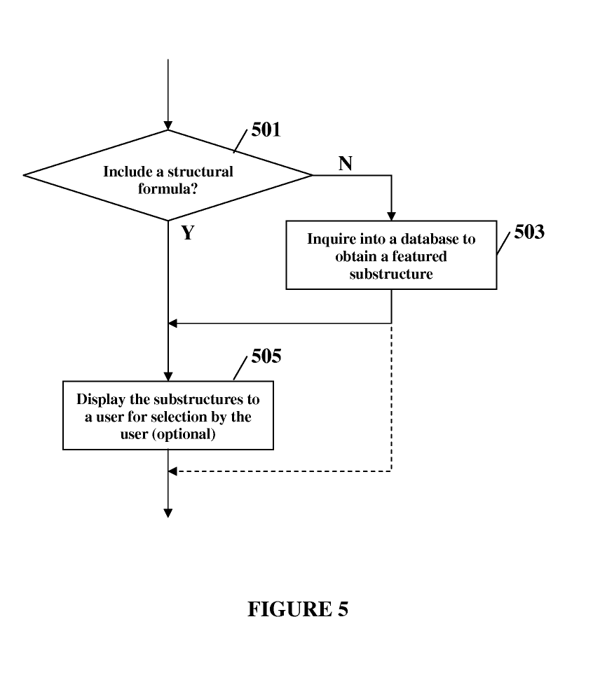

FIG. 5 is a schematic flow diagram showing the steps comprised in step 405 shown in FIG. 4 according to one embodiment of the present invention.

As shown in FIG. 5, once the process proceeds to step 405, step 501 is first executed. At step 501, it is judged whether the query request includes a chemical structural formula. Here, the chemical structural formula may be in an image format, a 3D image format, a SMILES format or an INCHI format, or the like. If the query request does not include the chemical structural formula, the process proceeds to step 503; otherwise, the process proceeds to step 505.

At step 503, an inquiry into a repository is made based on information in the query request to obtain a related featured substructure. Usually, the query request includes names of a chemical substance, and keywords of the names, etc. Since the repository stores information of the chemical substance and a featured substructure thereof in association with each other as described above, the featured substructure can be quickly obtained by making an inquiry into the repository.

At step 505, the obtained structural formula is displayed to a user for selection by the user, and the selected structural formula is determined as a featured substructure as a retrieval condition. At step 505, the user can also select to exclude some substructures as a featured substructure. That is, the user hopes to obtain a chemical substance that does not include the excluded substructures.

In addition, step 505 can be executed repeatedly a plurality of times, until the user determines that no more selection is made, and the structural formula the user finally selects is determined as a featured substructure as a retrieval basis.

Step 505 is optional. As shown by dotted lines in FIG. 5, it is also possible to use the featured substructure obtained at step 503 directly for retrieval, without the necessity of further selection by the user. In this case, step 505 in FIG. 5 is not executed.

Alternatively, if it is determined at step 501 that the query request includes a substructure requested to be inquired about, the substructure requested to be inquired about can be obtained at step 501. Then, the obtained substructure requested to be inquired about is used as a featured substructure for query. For example, if the user knows that a substructure of a pesticide has a killing function on certain pests and hopes to inquire about a plurality of pesticides having the function, the user directly inputs the substructure in the query request and uses the substructure as a featured substructure for query. In this case, it is possible not to execute step 505.

At step 407, based on the obtained featured substructure, the chemical substances matching the featured substructure are determined.

The comparison of substructures can be made using the existing methods in the prior art, such as “An algorithm for subgraph isomorphism”, JR Ullmann-Journal of the ACM (JACM), a graph matching algorithm published in 1976.

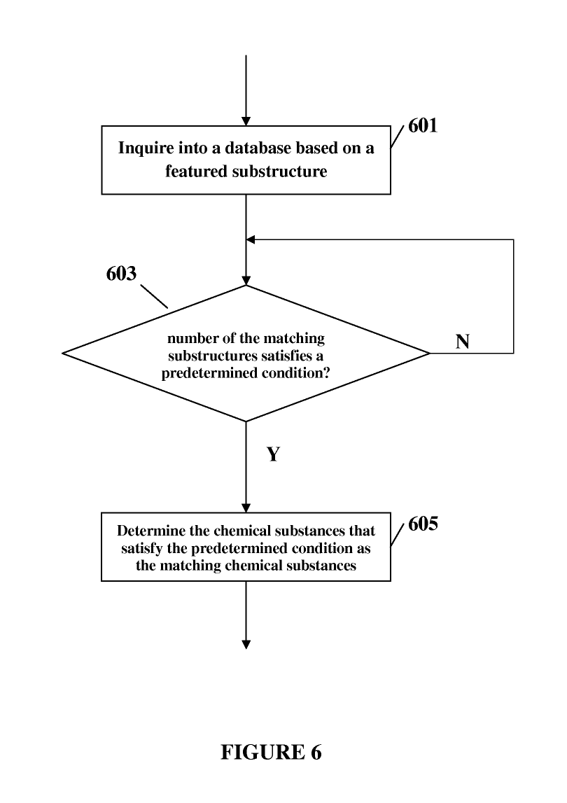

FIG. 6 is a schematic flow diagram showing the steps comprised in step 407 shown in FIG. 4 according to one embodiment of the present invention.

As shown in FIG. 6, once the process proceeds to step 407, step 601 is first executed. At step 601, based on the featured substructure determined at step 405, information of chemical substances that wholly or partially match the featured substructure is retrieved.

At step 603, it is judged whether the number of substructures of each chemical substance among the retrieved chemical substances that match the featured substructure satisfies a predetermined condition. The predetermined condition can be one or more of a predetermine threshold of the number, a ranking threshold of the number, and a predetermined threshold of a ratio of the number to the total number of the retrieved featured substructures. If the predetermined condition is not satisfied, step 603 is executed with respect to the next chemical substance. Otherwise, the process proceeds to step 605.

For example, there are three featured substructures for retrieval, i.e., SubStr1-1, SubStr1-2, and SubStr1-3. After retrieval, it is concluded that substances matching SubStr1-1 are ChCpd1-ChCpd3 and ChCpd8-ChCpd11, substances matching SubStr1-2 are ChCpd1-ChCpd4, and substances matching SubStr1-3 are ChCpd1-ChCpd2 and ChCpd4-ChCpd11.

If the predetermined condition is that the number of the matching substructures is greater than or equal to 3, the matching substances are ChCpd1 and ChCpd2 that match three substructures.

Alternatively, if the predetermined condition is that the number ranks top 2, then the matching substances are ChCpd1-ChCpd4 and ChCpd8-ChCpd11.

Alternatively, if the predetermined condition is that the ratio of the number to the total number of the retrieved featured substructures is greater than 50%, the matching substances are ChCpd1-ChCpd4 and ChCpd8-ChCpd11.

At step 605, the chemical substances that satisfy the predetermined condition are determined to be other chemical substances that match the featured substructure. In addition, it is also possible to provide naming information of said other chemical substances to the user for use.

At step 409, the process ends.

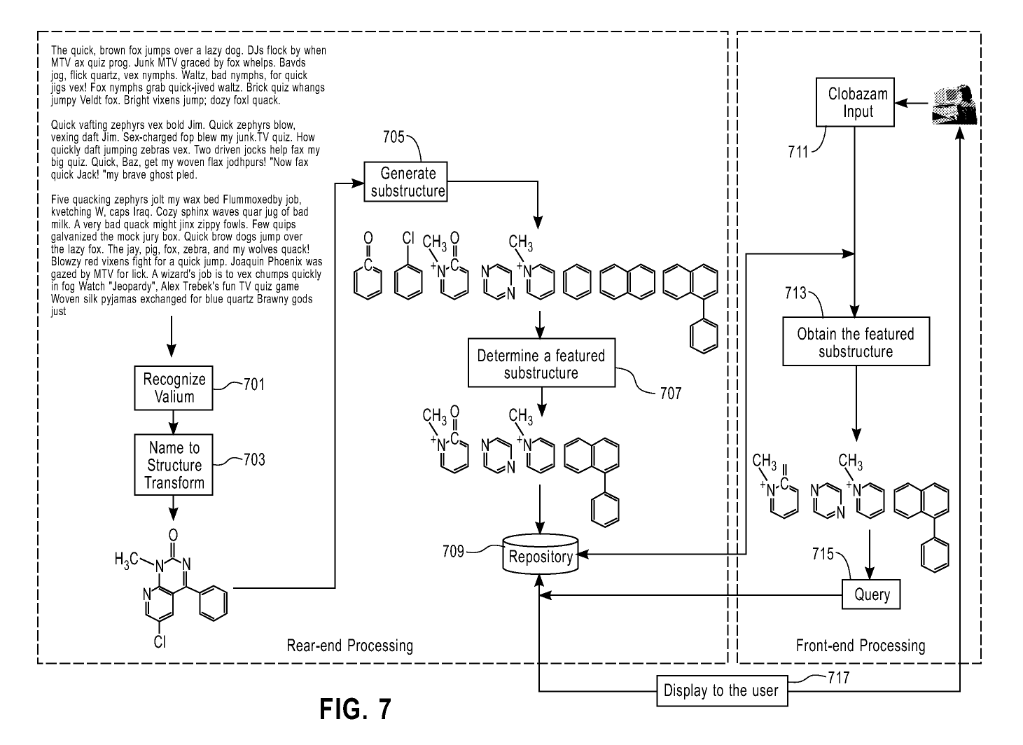

FIG. 7 is a schematic view showing an example of the application of one embodiment of the present invention in the biomedical field.

At step 701, a name of each drug in a kind of drugs having a specific function is recognized from the existing data. As shown in FIG. 7, the recognized name of a drug having a calming function in this example is Valium.

At step 703, the name of the drug is transformed into a chemical structural formula.

At step 705, the chemical structural formula is divided into various substructures.

At step 707, a featured substructure of each drug is determined.

At step 709, the featured substructure of each drug and the name of the drug are stored in a database in association with each other.

At step 711, a user inputs a query request. The query request includes a name of the drug to be inquired about.

At step 713, a featured substructure of the drug is inquired about from the database based on the name information.

At step 715, based on the obtained featured substructure, all drugs that wholly or partially match the featured substructure are inquired about from the database.

At step 717, names of all drugs of which the number of matching substructures satisfies the predetermined condition are displayed to the user.

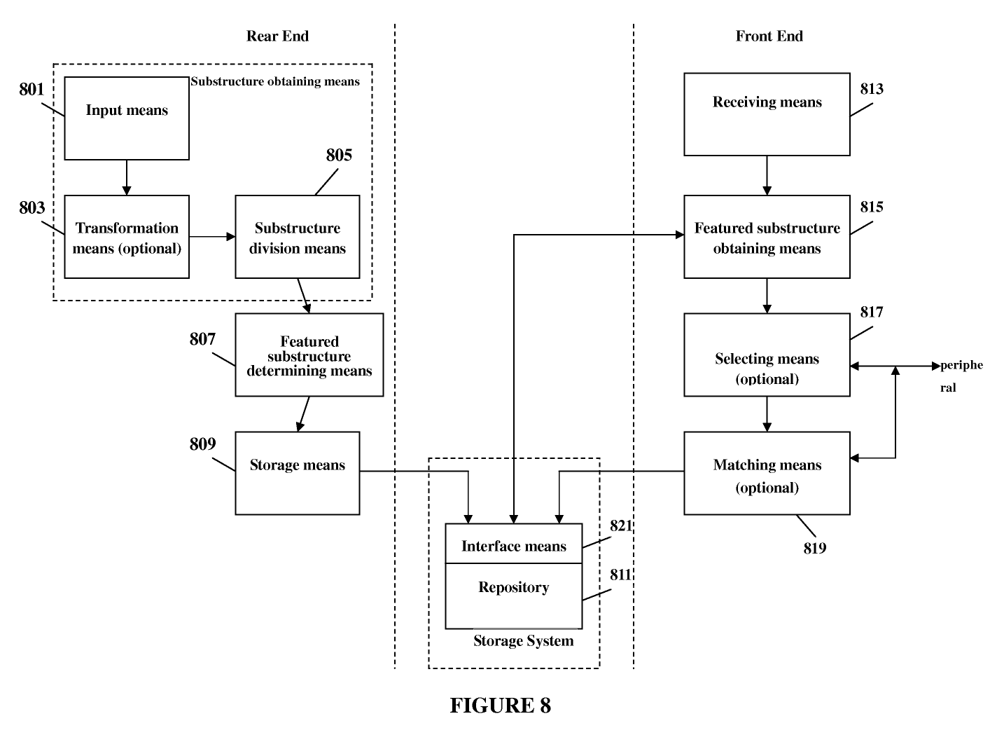

FIG. 8 is a schematic block diagram showing a system for storing and matching a chemical structural formula according to one embodiment of the present invention.

As shown in FIG. 8, the system comprises a front end, a rear end and a storage device therebetween. The rear end of the system comprises input means 801, transformation mean 803 (optional), substructure division means 805, featured substructure determination means 807, and storage means 809. The front end of the system comprises receiving means 813, featured substructure obtaining means 815, selecting means 817 (optional) and matching means 819. The storage system between the rear end and the front end comprises interface means 821 and a repository 811. Alternatively, the storage system can be combined into either the front end or the rear end as one part thereof.

The input means 801 is used to receive information of a plurality of chemical substances having the same or similar functions, which was obtained by the existing tool from the existing data source.

The transformation means 803 is optional. If information of a chemical substance received by the transformation means 803 from the input means 801 includes a chemical structural formula, then the transformation means 803 does not need to perform any operation. If the information of a chemical substance received by the transformation means 803 from the input means 801 does not include the chemical structural formula but a name of the chemical substance, then the transformation means 803 transforms the name of the chemical substance into its chemical structural formula.

The substructure division means 805 divides the chemical structural formula received from the transformation means 803 into various substructures. As described above, the substructure division process can be carried out using the prior art.

The featured substructure determining means 807 determines a featured substructure of the chemical substance from the divided substructures.

Specifically, the featured substructure determining means 807 first performs clustering of chemical substances based on the existing data to obtain a kind of chemical substances having the same or similar functions. Using the existing technologies, the clustering process may comprise the following processes:
For each literature (patent literature, paper, or technical report), representing it as a group of terms; for example, this group of terms may include only names of chemical substances, or include names of chemical substances, names of diseases, and protein, etc.; and
Performing clustering of the entire group of terms using LDA, PLSA or LSA.

For example, regarding drugs, it is possible to determine which drugs can be used to treat a certain disease or have a certain curative effect according to pathogenic genes, names of diseases caused, and induced protein and other substances and their co-occurrence condition in medical literature. Taking another example, regarding detergents, the detergents which can be used to cleansing food are classified into a kind, and the detergents which can be used to cleansing non-food are classified into another kind.

Then, the featured substructure determining means 807 collects statistics of the number of times each substructure of a chemical substance among a kind of chemical substances obtained by clustering occurs in chemical structural formulas of all chemical substances of this kind. Thereafter, the featured substructure determining means 807 judges whether the number of times obtained in the statistics satisfies a predetermined condition, and if it satisfies the predetermined condition, it is considered that the substructure is a featured substructure of the chemical substance. The predetermined condition is one or more of a predetermined threshold of the number of occurrences, a ranking threshold of the number of occurrences, and a predetermined threshold of a ratio of the number of occurrences to the total number of all chemical substances. In summary, the featured substructure determining means 807 ranks a list of names according to relevancy for each clustering, and selects, for each clustering, a name of a chemical substance which ranks first, and selects a structure which occurs most frequently as a structure of interest (i.e., a structure having a functional discrimination).

Of course, as described above, the featured substructure can be selectively determined according to the prior knowledge of a user.

The associative storage means 809 stores, in the repository 811, all featured substructures determined for each chemical substance by the featured substructure determining means 807 and information of the chemical substance in association with each other.

The repository 811 is used to store the information of the chemical substance and its featured substructures in association with each other.

The interface means 821 is connected to the repository 811 and other devices, and the other devices access the repository 811 via the interface means 821.

The receiving means 813 receives a query request inputted by the user. The query request inputted by the user may comprise a certain name of a certain chemical substance or one or more featured substructures of a certain chemical substance known to the user.

If the query request inputted by the user includes a substructure requested to be inquired about, the featured substructure obtaining means 815 can obtain the substructure requested to be inquired about and determine the substructure as a featured substructure. Otherwise, the featured substructure obtaining means 815 inquires into the repository 811 according to a name included in the query request so as to obtain a featured substructure associated with the name.

The selecting means 817 is optional. It is used to send the received featured substructure to a display device for display to the user for selection by the user. As described above, the selection is not limited to once but can be made by the user plural times. For example, the user may select some featured substructures so as to obtain chemical substances having a specific efficacy due to presence of these featured substructures. Of course, the user can also exclude some featured substructures so as to obtain chemical substances having a specific efficacy due to absence of these featured substructures.

Based on the featured substructure provided by the selecting means 817, the matching means 819 inquires into the repository 811 about chemical substances that wholly or partially match the featured substructure. The matching means 819 judges whether the number of substructures of each chemical substance obtained from the query which match the featured substructure satisfies the predetermined condition. If it satisfies the predetermined condition, information of the chemical substance that satisfies the predetermined condition is displayed to the user.

The present invention is described above by way of embodiments. In the present invention, the concept of a featured substructure, i.e. a substructure having a functional discrimination, is first presented, and information of a chemical substance is associated and matched based on the featured substructure, so that the present invention is capable of retrieving a plurality of chemical substances having the same or similar functions, irrespective of which nomenclature is used to name the chemical substances. Furthermore, the match in the prior art is complete match, and for example, a query request includes a certain keyword, and a query result is just chemical substance information including the keyword. However, in the present invention, the query request uses a featured substructure, and the query result is chemical substance information that is determined according to whether the matching condition between substructures of a chemical substance and its featured substructure satisfies the predetermined condition, and thus the present invention actually uses partial match. Therefore, the query result of the present invention covers a broader scope.

The present invention may be particularly useful in a network system. Most network systems now allow users to make retrieval using keywords. If the users want to make retrieval for their products such as a drug Penicillin, in addition to the name of this drug, the users need to make retrieval using another 40 names like “Abbocillin” and “Galofak”, all of which refer to the same drug. If a certain chemical structure of a detergent causes diseases, the users may exclude the chemical structure when making retrieval using the present invention, thereby obtaining a safe detergent without including the chemical structure. By using the present invention, it is possible to transform a retrieval keyword into a structural representation and make retrieval using the structural representation, so that the retrieval is independent of any specific nomenclature, and then which contents along with the search result are to be displayed to the users are determined according to the structural similarity, thereby retrieving all products having the same or similar functions and greatly reducing costs and time-consumption.

The respective embodiments of the present invention can be carried out in any appropriate mode, including hardware, software, firmware or combination thereof. Alternatively, it is possible to at least partially carry out the embodiment of the present invention as computer software executed on one or more data processors and/or a digital signal processor. The components and modules of the embodiment of the present invention can be implemented physically, functionally and logically in any suitable manner. Indeed, the function can be realized in a single member or in a plurality of members, or as a part of other functional members. Thus, it is possible to implement the embodiment of the present invention in a single member or distribute it physically and functionally between different members and a processor.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the computer or other programmable data processing apparatus, create means for implementing the functions/acts specified in the blocks of the flowchart illustrations and/or block diagrams.

These computer program instructions may also be stored in a computer readable medium that can direct a computer or other programmable data processing apparatus to function in a particular manner, such that the instructions stored in the computer readable medium produce an article of manufacture including instruction means which implement the functions/acts specified in the blocks of the flowchart illustrations and/or block diagrams.

The computer program instructions may also be loaded onto a computer or other programmable data processing apparatus to cause a series of operational steps to be performed on the computer or other programmable data processing apparatus to produce a computer implemented process such that the instructions which execute on the computer or other programmable apparatus provide processes for implementing the functions/acts specified in the blocks of the flowchart illustrations and/or block diagrams.

The present invention is described by use of detailed illustration of the embodiments of the present invention, and these embodiments are provided as examples and do not intend to limit the scope of the present invention. Although these embodiments are described in the present invention, modifications and variations on these embodiments will be apparent to those of ordinary skill in the art. Therefore, the above illustration of the exemplary embodiments does not confine or restrict the present invention. Other changes, substitutions and modifications are also possible, without departing from the spirit and scope of the invention defined by the appended claims.

What is claimed is:

1. A method of processing information of a chemical substance, comprising: obtaining substructures of a chemical structural formula of said chemical substance;
determining, with a computer, a featured substructure of said chemical substance from the obtained substructures, wherein said featured substructure is a structure having a functional discrimination; and
storing said featured substructure of said chemical substance.

2. The method according to claim 1, wherein the step of obtaining substructures further comprises:
obtaining information about said chemical substance;
in response to the obtained information about said chemical substance is not the chemical structural formula of said chemical substance, transforming the information of said chemical substance into the chemical structural formula; and
dividing the chemical structural formula of said chemical substance into substructures.

3. The method according to claim 2, wherein the step of determining a featured substructure comprises:
obtaining the number of times at least one substructure of said chemical substance occurs in substructures of other chemical substances having the same or similar functions as or to those of said chemical substance; and
in response to said number satisfies a predetermined condition, determining that said at least one substructure is a featured substructure of said chemical substance.

4. The method according to claim 3, wherein the predetermined condition is one or more of a predetermined threshold of said number, a ranking threshold of said number, and a predetermined threshold of a ratio of said number to a total number of said other chemical substances.

5. A method of inquiring about information of a chemical substance, comprising:
obtaining a query request for the chemical substance; and
obtaining, using a computer, a featured substructure of the chemical substance to be inquired about, wherein said featured substructure is a substructure having a functional discrimination.

6. The method according to claim 5, further comprising:
determining other chemical substances that match said featured substructure, based on said featured substructure.

7. The method according to claim 6, wherein the step of obtaining a featured substructure comprises:
retrieving said featured substructure from a repository based on information included in said query request, wherein said repository stores featured substructures of a plurality of chemical substances.

8. The method according to claim 7, further comprising:
presenting said featured substructure retrieved to a user for selection by the user; and
wherein the step of determining the matching other chemical substances is matching other chemical substances based on the featured substructure selected by the user.

9. The method according to claim 7, further comprising:
in response to the number of the matching featured substructures satisfying a predetermined condition, determining to realize the matching; and
wherein the predetermined condition is one or more of a predetermined threshold of said number, a ranking threshold of said number, and a predetermined threshold of a ratio of the number of the matching featured substructures to a total number of said retrieved featured substructures.

10. The method according to claim 6, wherein if the obtained query request includes a substructure to be excluded, other chemical substances having the substructure to be excluded are excluded from the matching other chemical substances, in the step of determining the matching other chemical substances.

11. The method according to claim 5, wherein the step of obtaining a query request for the chemical substance comprises obtaining a substructure requested to be inquired about, and the step of obtaining a featured substructure of said chemical substance comprises: determining the substructure requested to be inquired about as a featured substructure to be inquired about; and
wherein said method further comprises: determining a chemical substance that matches said featured substructure, based on said featured substructure.

12. A storage system for storing a chemical substance and a featured substructure in association with each other, comprising:
interface means for, responsive to an external request, transmitting information of said chemical substance and its featured substructure, wherein said featured substructure is a substructure having a functional discrimination; and
a repository, coupled to said interface means, for storing the information of said chemical substance and its featured substructure in association with each other.

13. A system for processing information of a chemical substance, comprising:
substructure obtaining means for obtaining substructures of a chemical structural formula of said chemical substance;
featured substructure determining means for determining a featured substructure of said chemical substance from the obtained substructures, wherein said featured substructure is a substructure having a functional discrimination; and
storage means for storing said featured substructure of said chemical substance.

14. The system according to claim 13, wherein said substructure obtaining means comprises:
input means for obtaining information about said chemical substance;
transformation means for, if the obtained information about said chemical substance is not the chemical structural formula of said chemical substance, transforming the information of said chemical substance into the chemical structural formula; and
substructure division means for dividing the chemical structural formula of said chemical substance into substructures.

15. The system according to claim 14, wherein said featured substructure determining means is further used for obtaining the number of times at least one substructure of said chemical substance occurs in substructures of other chemical substances having the same or similar functions as or to those of said chemical substance, and if said number satisfies a predetermined condition, determining that said at least one substructure is a featured substructure of said chemical substance.

16. The system according to claim 15, wherein the predetermined condition is one or more of a predetermined threshold of said number, a ranking threshold of said number, and a predetermined threshold of a ratio of said number to a total number of said other chemical substances.

17. A system for inquiring about information of a chemical substance, comprising:
receiving means for obtaining a query request for the chemical substance; and
featured substructure obtaining means for obtaining a featured substructure of the chemical substance to be inquired about, wherein said featured substructure is a substructure having a functional discrimination.

18. The system according to claim 17, further comprising:
matching means for determining other chemical substances that match said featured substructure, based on said featured substructure.

19. The system according to claim 18, wherein said featured substructure obtaining means is further used for retrieving said featured substructure from the repository based on information included in said query request, wherein said repository stores featured substructures of a plurality of chemical substances.

20. The system according to claim 19, further comprising:
selecting means for presenting said featured substructure retrieved to a user for selection by the user; and
wherein said matching means matches other chemical substances based on the featured substructure selected by the user.

21. The system according to claim 19, wherein said matching means is further used for determining to realize the matching, in response to the number of the matching featured substructures satisfying a predetermined condition; and
wherein the predetermined condition is one or more of a predetermined threshold of said number, a ranking threshold of said number, and a predetermined threshold of a ratio of the number of the matching featured substructures to a total number of said retrieved featured substructures.

22. The system according to claim 18, wherein if the obtained query request includes a substructure to be excluded, said matching means excludes other chemical substances having the substructure to be excluded, from the matching other chemical substances.

23. The system according to claim 17, wherein said receiving means is further used for obtaining a substructure requested to be inquired about, and said featured substructure obtaining means is further used for determining the substructure requested to be inquired about as a featured substructure to be inquired about; and
wherein said system further comprises:
matching means for determining a chemical substance that matches said featured substructure, based on said featured substructure.
